(19) United States
(12) Patent Application Publication
(10) Pub. No.: US 2024/0114602 A1
(43) Pub. Date: Apr. 4, 2024

(54) HEATING COOKING APPARATUS

(71) Applicant: SHARP KABUSHIKI KAISHA, Sakai City, Osaka (JP)

(72) Inventors: YU SHINOHARA, Sakai City, Osaka (JP); MASAYUKI IWAMOTO, Sakai City, Osaka (JP); KAORU TOMISHIGE, Sakai City, Osaka (JP)

(21) Appl. No.: 18/275,690

(22) PCT Filed: Feb. 15, 2022
(86) PCT No.: PCT/JP2022/005927

§ 371 Date: Aug. 3, 2023

(30) Foreign Application Priority Data
Feb. 16, 2021 (JP) 2021-022581

(51) Int. Cl. H05B 6/64

(52) U.S. Cl. CPC H05B 6/6414

(57) ABSTRACT

A heating cooking apparatus includes a heating cooking chamber, a slide rail, a slide plate, a lid portion, a rotation shaft portion, and a holding portion. The heating cooking chamber includes a plate portion disposed at the outer periphery of an opening. The slide rail extends along a first predetermined direction. The slide plate moves along the slide rail. The lid portion is attached to the slide plate and opens and closes the opening. The rotation shaft portion rotates the slide rail using a second predetermined direction orthogonal to the first predetermined direction as a rotation axis. The holding portion holds the slide rail to be freely rotatable with respect to the heating cooking chamber.

### TECHNICAL FIELD

The present invention relates to a heating cooking apparatus.

### BACKGROUND ART

PTL 1 discloses a pull-out type heating cooking apparatus. The pull-out type heating cooking apparatus disclosed in PTL 1 includes a heating cooking apparatus main body and a pull-out body. The heating cooking apparatus main body includes a heating cooking chamber.

From a state in which the pull-out body is accommodated in the heating cooking chamber, the pull-out body can be pulled out toward the outside of the heating cooking apparatus main body. The pull-out body includes a lid portion. In a state in which the pull-out body is retracted into the heating cooking chamber, the lid portion closes an opening on the front side of the heating cooking chamber.

### CITATION LIST

### Patent Literature

PTL 1: JP 2011-089738 A

### SUMMARY OF INVENTION

### Technical Problem

When a lid portion is moved to a position at which the lid portion covers an opening, the lid portion comes into close contact with a plate portion disposed at the outer periphery of the opening, or is held at a predetermined gap (0.5 mm, for example) from the plate portion. In recent years, there has been a demand for accurately maintaining parallelism between the plate portion and the lid portion when the lid portion is moved to the position at which the lid portion covers the opening.

In light of the problem described above, an object of the present invention is to provide a heating cooking apparatus capable of accurately maintaining parallelism between a plate portion and a lid portion when the lid portion is moved to a position at which the lid portion covers an opening.

### Solution to Problem

A heating cooking apparatus according to the present invention includes a heating cooking chamber, a slide rail, a slide plate, a lid portion, a rotation shaft portion, and a holding portion. The heating cooking chamber includes a plate portion disposed at an outer periphery of an opening. The slide rail extends along a first predetermined direction. The slide plate moves along the slide rail. The lid portion is attached to the slide plate and opens and closes the opening. The rotation shaft portion rotates the slide rail using a second predetermined direction as a rotation axis, the second predetermined direction being orthogonal to the first predetermined direction. The holding portion holds the slide rail to be freely rotatable with respect to the heating cooking chamber.

### Advantageous Effects of Invention

A heating cooking apparatus according to the present invention can accurately maintain parallelism between a plate portion and a lid portion when the lid portion is moved to a position at which the lid portion covers an opening.

### BRIEF DESCRIPTION OF DRAWINGS

FIG. 1 is a perspective view illustrating a pull-out type heating cooking apparatus according to an embodiment of the present invention.

FIG. 2 is a right side view illustrating the pull-out type heating cooking apparatus according to the present embodiment.

FIG. 3 is a top view illustrating the pull-out type heating cooking apparatus according to the present embodiment.

FIG. 4 is a front view illustrating the pull-out type heating cooking apparatus according to the present embodiment.

FIG. 5 is an exploded perspective view illustrating a pull-out body according to the present embodiment.

FIG. 6 is a bottom view illustrating the pull-out type heating cooking apparatus according to the present embodiment.

FIG. 7 is a bottom view illustrating the pull-out type heating cooking apparatus according to the present embodiment.

FIG. 8 is a cross-sectional view illustrating the pull-out type heating cooking apparatus taken along a section line VIII in FIG. 7.

FIG. 9 is a cross-sectional view illustrating the pull-out type heating cooking apparatus taken along a section line IX in FIG. 7.

FIG. 10 is a bottom view illustrating the pull-out type heating cooking apparatus according to the present embodiment.

FIG. 11 is a bottom view illustrating the pull-out type heating cooking apparatus according to the present embodiment.

FIG. 12 is a cross-sectional view illustrating the pull-out type heating cooking apparatus taken along a section line XII in FIG. 11.

FIG. 13 is a perspective view illustrating a support member according to the present embodiment.

FIG. 14 is a block diagram illustrating a configuration of the pull-out type heating cooking apparatus according to the present embodiment.

FIG. 15 is a cross-sectional view illustrating a connecting member and a member to be connected according to the present embodiment.

FIG. 16 is a cross-sectional view illustrating the connecting member and the member to be connected according to the present embodiment.

FIG. 17 is a flowchart for explaining a cooking method by the pull-out type heating cooking apparatus according to the present embodiment.

FIG. 18 is a perspective view illustrating an external appearance of a cabinet to which the pull-out type heating cooking apparatus according to the present embodiment is attached.

### DESCRIPTION OF EMBODIMENTS

Hereinafter, embodiments of a pull-out type heating cooking apparatus according to the present invention will be described with reference to the drawings. Note that, in the drawings, the same or equivalent components are denoted by the same reference numerals and signs, and description thereof will not be repeated.

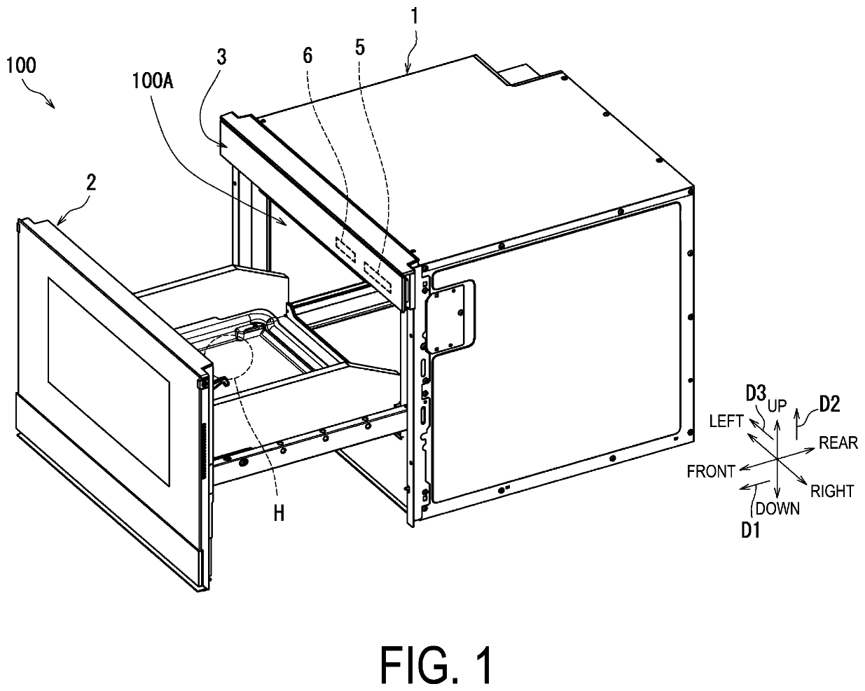

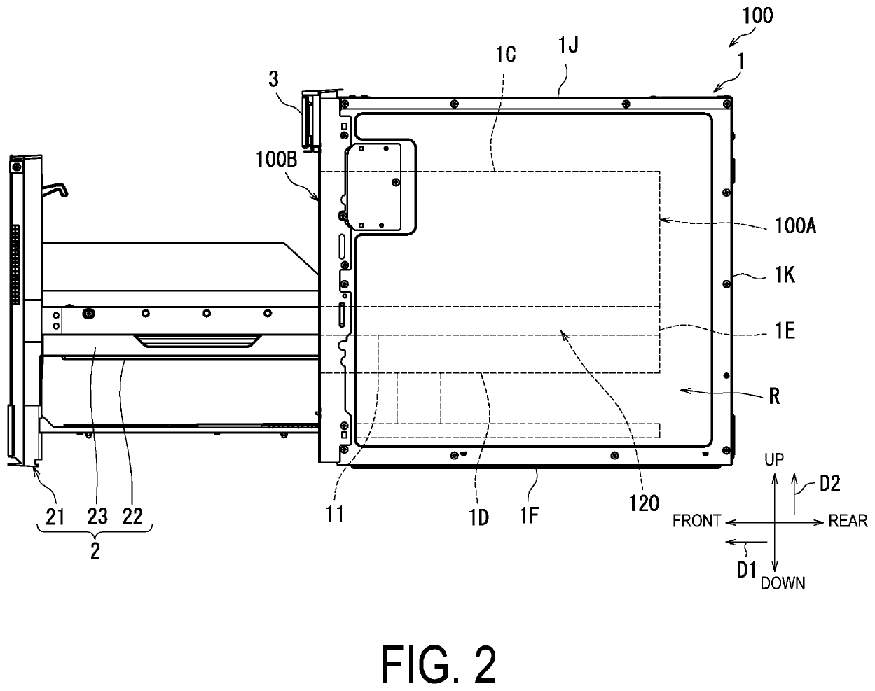

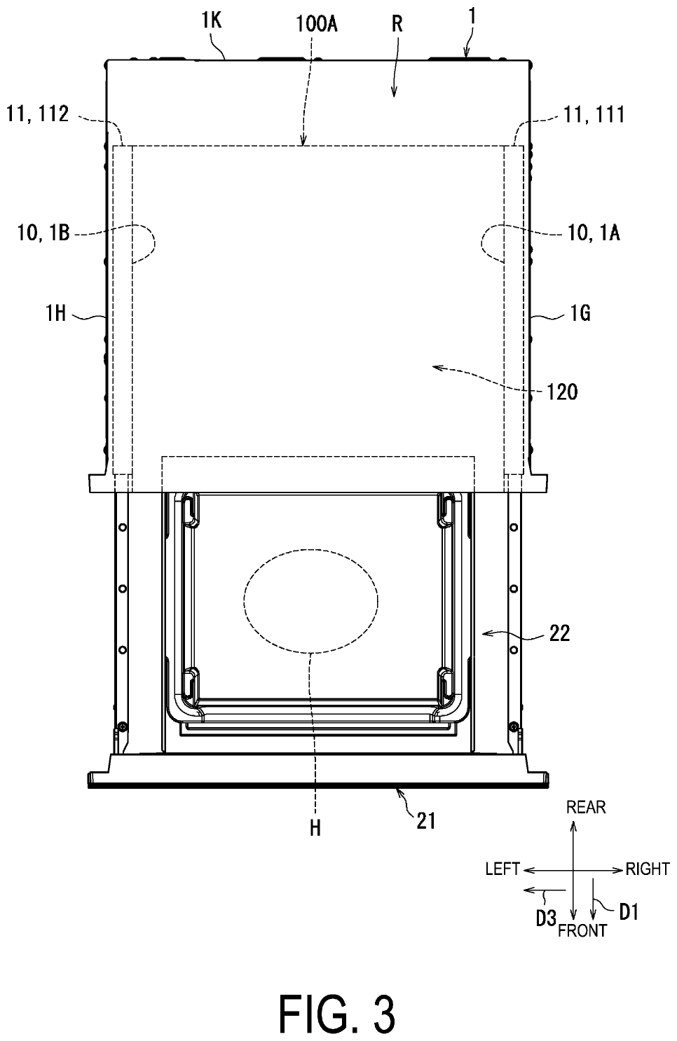

A pull-out type heating cooking apparatus 100 according to the present embodiment will be described with reference to FIG. 1 to FIG. 3. FIG. 1 is a perspective view illustrating the pull-out type heating cooking apparatus 100. FIG. 2 is a right side view illustrating the pull-out type heating cooking apparatus 100. FIG. 3 is a top view illustrating the pull-out type heating cooking apparatus 100. More specifically, FIG. 1 to FIG. 3 illustrate the pull-out type heating cooking apparatus 100 in a state in which a pull-out body 2 is pulled out. Further, FIG. 1 illustrates an external appearance of the pull-out type heating cooking apparatus 100 as viewed diagonally from the upper front right. The pull-out type heating cooking apparatus 100 is an example of a “heating cooking apparatus”.

As illustrated in FIG. 1, the pull-out type heating cooking apparatus 100 heats and cooks an object H to be heated. The object H to be heated is, for example, a food product. The pull-out type heating cooking apparatus 100 includes a heating chamber 1, the pull-out body 2, an operation panel 3, and a heating cooking chamber 100A.

In the present embodiment, a side at which the operation panel 3 of the pull-out type heating cooking apparatus 100 is disposed is defined as a front side of the pull-out type heating cooking apparatus 100, and a side opposite to the front side (rear face side) is defined as a rear side of the pull-out type heating cooking apparatus 100. Further, a right side when the pull-out type heating cooking apparatus 100 is viewed from the front side is defined as a right side of the pull-out type heating cooking apparatus 100, and a side opposite to the right side is defined as a left side of the pull-out type heating cooking apparatus 100. Further, in a direction orthogonal to a front-rear direction and a left-right direction of the pull-out type heating cooking apparatus 100, a side at which the operation panel 3 is disposed is defined as an upper side of the pull-out type heating cooking apparatus 100, and a side opposite to the upper side (bottom side) is defined as a lower side of the pull-out type heating cooking apparatus 100. Note that these orientations do not limit an orientation of the pull-out type heating cooking apparatus 100 according to the present invention in use.

As illustrated in FIG. 1 to FIG. 3, the heating chamber 1 is a box-like member. Specifically, the heating chamber 1 includes a right outer wall 1G, a left outer wall 1H, a top outer wall 1J, a bottom outer wall 1F, and a back outer wall 1K. The heating chamber 1 accommodates the heating cooking chamber 100A.

The pull-out body 2 can be pulled out in a first direction D1 from the heating cooking chamber 100A. The first direction D1 is the forward direction. Further, a second direction D2 intersects the first direction D1. In the present embodiment, the second direction D2 is orthogonal to the first direction D1. In the present embodiment, the second direction D2 is the upward direction. Specifically, the pull-out body 2 includes a lid portion 21, a placing portion 22, and a support portion 23.

The heating cooking chamber 100A includes an accommodation space 120 that accommodates the object H to be heated. The shape of the heating cooking chamber 100A is, for example, a substantially rectangular parallelepiped shape. Specifically, the heating cooking chamber 100A includes a pair of side wall portions 10, a back wall 1E, and an opening portion 100B. The opening portion 100B is an example of an “opening”. The back wall 1E intersects the first direction D1. The opening portion 100B faces the back wall 1E. The opening portion 100B opens toward the first direction D1. The opening portion 100B communicates with the outside of the heating cooking chamber 100A. The pair of side wall portions 10 face each other in a third direction D3. The third direction D3 is the leftward direction. Specifically, the pair of side wall portions 10 includes a right wall 1A and a left wall 1B. The heating cooking chamber 100A further includes a top wall 1C and a bottom wall 1D. Materials of the right wall 1A, the left wall 1B, the top wall 1C, the bottom wall 1D, and the back wall 1E are, for example, a metal.

The heating chamber 1 further includes a space R between the heating chamber 1 and the heating cooking chamber 100A. Specifically, the heating chamber 1 further includes the space R between the bottom wall 1D and the bottom outer wall 1F. The heating chamber 1 further includes the space R between the right wall 1A and the right outer wall 1G. The heating chamber 1 further includes the space R between the left wall 1B and the left outer wall 1H. The heating chamber 1 further includes the space R between the top wall 1C and the top outer wall 1J. The heating chamber 1 further includes the space R between the back wall 1E and the back outer wall 1K.

As illustrated in FIG. 1, the operation panel 3 receives an operation from a user. The operation includes, for example, a cooking method for heating and cooking the object H to be heated, or information about movement of the lid portion 21 between the closed position and the open position thereof. Specifically, the operation panel 3 includes a display unit, a storage unit 6, and a control unit 5. The display unit displays various pieces of information. Specifically, the display unit includes a liquid crystal panel.

The storage unit 6 is constituted by a random access memory (RAM) and a read only memory (ROM). The storage unit 6 stores a control program for controlling an operation of each unit of the pull-out type heating cooking apparatus 100. The storage unit 6 stores setting information input by operating the display unit.

The control unit 5 is a hardware circuit that includes a processor such as a central processing unit (CPU). The control unit 5 executes the control program stored in the storage unit 6.

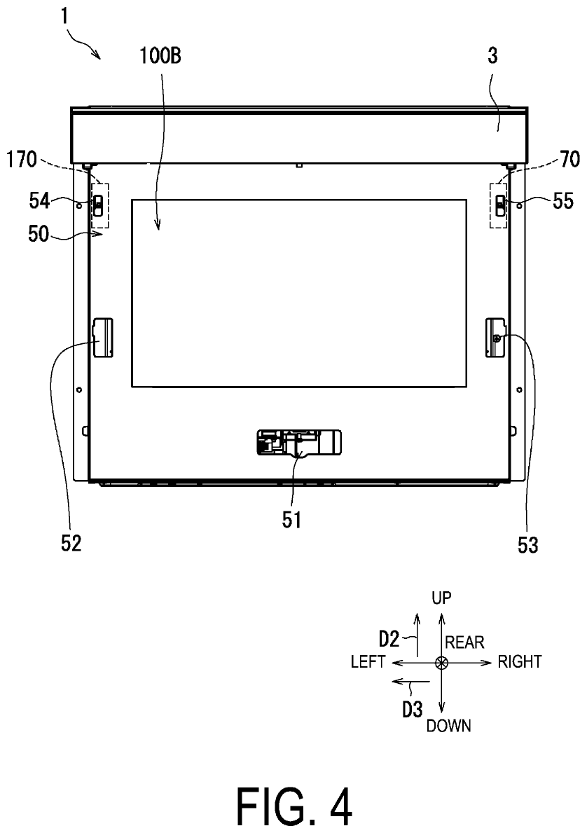

Next, a panel 50 will be further described with reference to FIG. 4. FIG. 4 is a front view illustrating the pull-out type heating cooking apparatus 100. More specifically, FIG. 4 is a front view illustrating the pull-out type heating cooking apparatus 100 in a state in which the pull-out body 2 is removed. As illustrated in FIG. 4, the pull-out type heating cooking apparatus 100 further includes the panel 50. The panel 50 is an example of a “plate portion”.

The panel 50 is disposed at the outer periphery of the opening portion 100B. The opening portion 100B has a rectangular shape, for example. The panel 50 is a plate-like member having a rectangular ring shape for example. The panel 50 includes a first through hole 51, a second through hole 52, a third through hole 53, a fourth through hole 54, and a fifth through hole 55.

The first through hole 51, the second through hole 52, the third through hole 53, the fourth through hole 54, and the fifth through hole 55 are formed around the opening portion 100B. Specifically, the first through hole 51 is formed at a position on a lower side of the opening portion 100B. The second through hole 52 is formed at a position on a left side of the opening portion 100B. The third through hole 53 is formed at a position on a right side of the opening portion 100B. The fourth through hole 54 is formed at a position on the left side of the opening portion 100B and on an upper side of the second through hole 52. The fifth through hole 55 is formed at a position on the right side of the opening portion 100B and on an upper side of the third through hole 53.

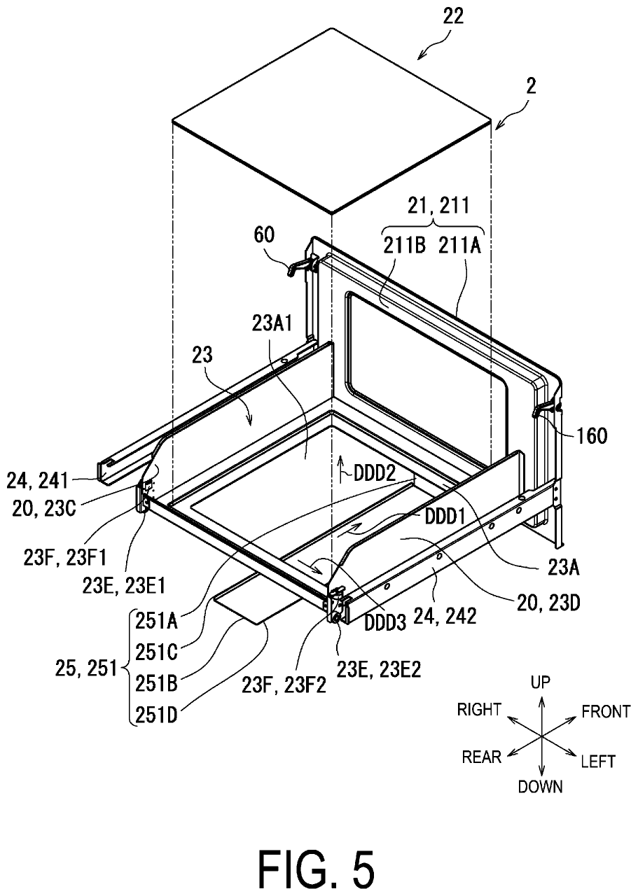

Next, the pull-out body 2 will be described in detail with reference to FIG. 5. FIG. 5 is an exploded perspective view illustrating the pull-out body 2 according to the present embodiment. As illustrated in FIG. 5, the pull-out body 2 further includes the lid portion 21 and a support member 25. The support member 25 is an example of a “slide plate”.

The support member 25 is a plate-like member 251. The plate-like member 251 has a first face 251A, a second face 251B, a third face 251C, and a fourth face 251D.

In the pull-out body 2 according to the present embodiment, a direction from the second face 251B toward the first face 251A is defined as a “first set direction DDD1”, a direction from the third face 251C toward the fourth face 251D is defined as a “third set direction DDD3”, and the upward direction orthogonal to the “first set direction DDD1” and the “third set direction DDD3” is defined as a “second set direction DDD2”.

The lid portion 21 is attached to the plate-like member 251. In other words, the plate-like member 251 supports the lid portion 21. Specifically, one end portion of the plate-like member 251 is attached at a center portion in the third set direction DDD3 of the lid portion 21 and below the placing portion 22. The plate-like member 251 extends in the direction opposite to the first set direction DDD1 from the lid portion 21.

The lid portion 21 includes a plate-like member 211. The plate-like member 211 has a first face 211A and a second face 211B. The first face 211A is disposed on the first set direction DDD1 side. The second face 211B is disposed on the side in the direction opposite to the first set direction DDD1.

The plate-like member 211 opens and closes the opening portion 100B of the heating cooking chamber 100A. Specifically, the plate-like member 211 moves between a closed position and an open position. The closed position indicates a position at which the plate-like member 211 closes the opening portion 100B. Specifically, the closed position indicates a position at which the panel 50 and the second face 211B face each other. More specifically, the closed position indicates a position at which the distance between the panel 50 and the second face 211B is a predetermined distance, or the panel 50 and the second face 211B come into contact with each other. The predetermined distance is, for example, 0.5 mm. The position at which the panel 50 and the second face 211B come into contact with each other is, for example, a position at which the panel 50 and the second face 211B come into close contact with each other. On the other hand, the open position is positioned further to the first direction D1 side than the closed position, and indicates a position at which the plate-like member 211 opens the opening portion 100B.

The object H to be heated can be placed on the placing portion 22. Specifically, the placing portion 22 has a placing surface on which the object H to be heated is placed. The material of the placing portion 22 is a non-metal, and is preferably ceramic or glass, for example.

The support portion 23 is attached to the second face 211B of the lid portion 21 and supports a peripheral edge portion of the placing portion 22 such that the placing portion 22 is held in a horizontal state. Specifically, the support portion 23 includes a bottom plate portion 23A and a pair of wall portions 20. The material of the support portion 23 is, for example, a metal.

The bottom plate portion 23A includes a rectangular opening 23A1. The rectangular opening 23A1 is positioned at substantially a center portion of the bottom plate portion 23A.

One wall portion of the pair of wall portions 20 includes a right side plate portion 23C, and the other wall portion of the pair of wall portions 20 includes a left side plate portion 23D. Each of the right side plate portion 23C and the left side plate portion 23D extends substantially along the first set direction DDD1. The right side plate portion 23C and the left side plate portion 23D face each other substantially in the third set direction DDD3. More specifically, the right side plate portion 23C and the left side plate portion 23D extend upward from the peripheral edge portion of the bottom plate portion 23A. The placing portion 22 is fitted among the lid portion 21, the right side plate portion 23C, and the left side plate portion 23D. The peripheral edge portion of the placing portion 22 is fixed to an upper surface of the peripheral edge portion of the bottom plate portion 23A.

The support portion 23 further includes a pair of rollers 23E and a pair of rollers 23F. The pair of rollers 23E and the pair of rollers 23F rotate as the pull-out body 2 moves. Specifically, one roller of the pair of rollers 23E includes a right side roller 23E1, and the other roller of the pair of rollers 23E includes a left side roller 23E2. The right side roller 23E1 and the left side roller 23E2 rotate about a rotation axis extending substantially along the third set direction DDD3. In addition, the right side roller 23E1 is attached to an end portion on the rear side (the side substantially in the direction opposite to the first set direction DDD1) of the right side plate portion 23C. The left side roller 23E2 is attached to an end portion on the rear side of the left side plate portion 23D. The right side roller 23E1 and the left side roller 23E2 are in contact with the bottom wall 1D.

Also, one roller of the pair of rollers 23F includes a right side roller 23F1, and the other roller of the pair of rollers 23F includes a left side roller 23F2. The right side roller 23F1 and the left side roller 23F2 rotate about a rotation axis extending substantially along the second set direction DDD2. The right side roller 23F1 is attached to the end portion on the rear side of the right side plate portion 23C. The left side roller 23F2 is attached to the end portion on the rear side of the left side plate portion 23D. The right side roller 23F1 is in contact with the right wall 1A. The left side roller 23F2 is in contact with the left wall 1B.

The placing portion 22 and the support portion 23 are accommodated in the heating cooking chamber 100A when the plate-like member 211 is positioned at the closed position. On the other hand, when the plate-like member 211 is positioned at the open position, the placing portion 22 and the support portion 23 are pulled out from the heating cooking chamber 100A in a state in which the pair of rollers 23E and the pair of rollers 23F are accommodated in the heating cooking chamber 100A.

A pair of rail members 11 will be described once again with reference to FIG. 2 and FIG. 3. As illustrated in FIG. 2 and FIG. 3, the pull-out type heating cooking apparatus 100 further includes the pair of rail members 11. Specifically, one rail member of the pair of rail members 11 includes a right side rail member 111, and the other rail member of the pair of rail members 11 includes a left side rail member 112. The right side rail member 111 and the left side rail member 112 face each other in the third direction D3.

Each of the right side rail member 111 and the left side rail member 112 is disposed in the heating chamber 1. Specifically, each of the right side rail member 111 and the left side rail member 112 is disposed between the heating chamber 1 and the heating cooking chamber 100A. More specifically, the right side rail member 111 is fixed on the right wall 1A in the space R between the right wall 1A and the right outer wall 1G. The left side rail member 112 is fixed on the left wall 1B in the space R between the left wall 1B and the left outer wall 1H. Particularly, each of the right side rail member 111 and the left side rail member 112 extends in the first direction D1.

Next, a pair of slide members 24 will be described with reference to FIG. 4 and FIG. 5. As illustrated in FIG. 4 and FIG. 5, the pull-out type heating cooking apparatus 100 further includes the pair of slide members 24. Specifically, one slide member of the pair of slide members 24 includes a right side slide member 241, and the other slide member of the pair of slide members 24 includes a left side slide member 242. The right side slide member 241 and the left side slide member 242 face each other substantially in the third set direction DDD3.

Each of the right side slide member 241 and the left side slide member 242 is disposed on the lid portion 21. Specifically, one end portion of the right side slide member 241 is attached to an edge portion on the right side (the side opposite to the third set direction DDD3) of the lid portion 21. One end portion of the left side slide member 242 is attached to an edge portion on the left side (the third set direction DDD3 side) of the lid portion 21. More specifically, each of the right side slide member 241 and the left side slide member 242 extends substantially in the direction opposite to the first set direction DDD1 from the lid portion 21.

The right side slide member 241 is inserted into the third through hole 53. The right side slide member 241 is slidably supported by the right side rail member 111. In addition, the left side slide member 242 is inserted into the second through hole 52. The left side slide member 242 is slidably supported by the left side rail member 112.

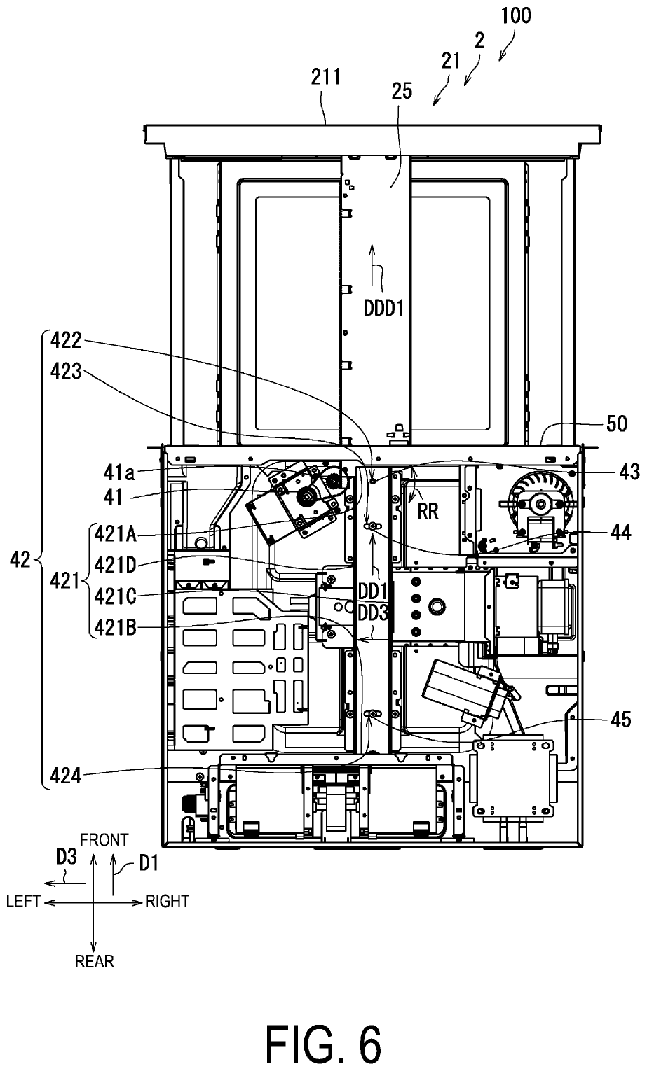

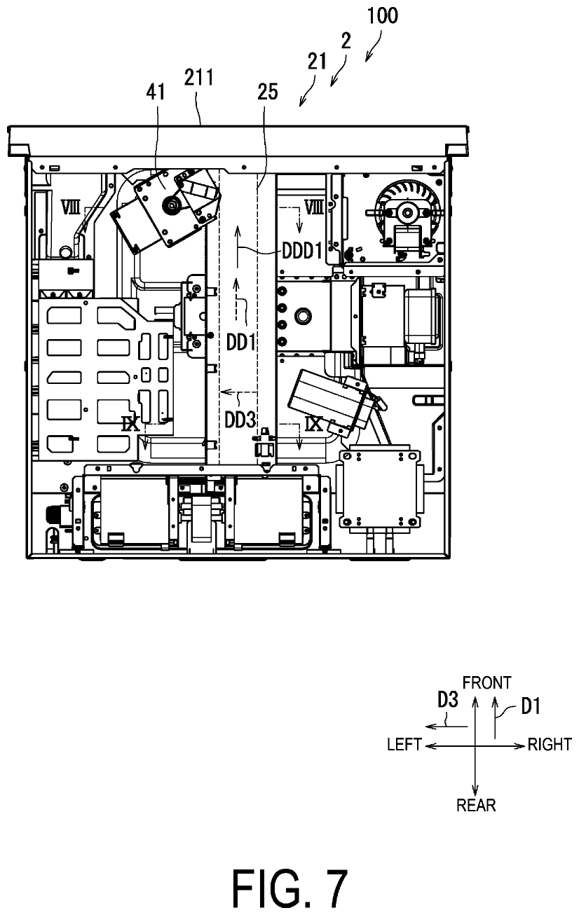

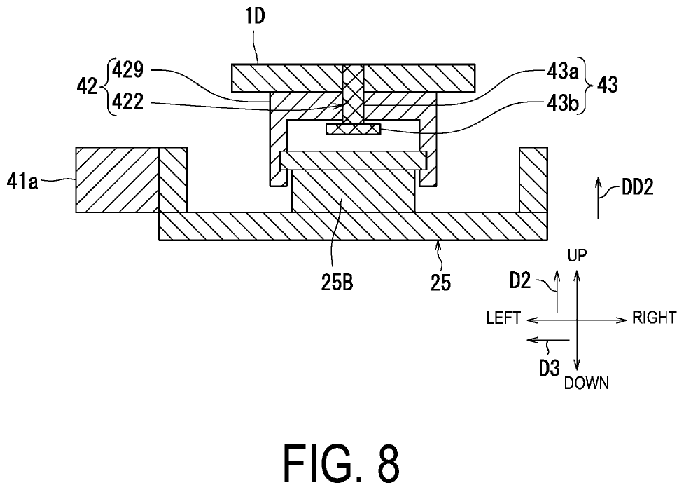

Next, a drive rail 42 will be described in with reference to FIG. 6 to FIG. 8. FIG. 6 and FIG. 7 are bottom views illustrating the pull-out type heating cooking apparatus 100 in a state in which the bottom outer wall 1F is removed. More specifically, FIG. 6 illustrates the pull-out type heating cooking apparatus 100 in a state in which the pull-out body 2 is pulled out. On the other hand, FIG. 7 illustrates the pull-out type heating cooking apparatus 100 in a state in which the pull-out body 2 is accommodated. FIG. 8 is a cross-sectional view illustrating the pull-out type heating cooking apparatus 100 taken along a section line VIII in FIG. 7.

As illustrated in FIG. 6 to FIG. 8, the pull-out type heating cooking apparatus 100 further includes the drive rail 42. The drive rail 42 is an example of a “slide rail”. The drive rail 42 includes a plate-like member 421. The plate-like member 421 has a first face 421A, a second face 421B, a third face 421C, and a fourth face 421D. In the drive rail 42 according to the present embodiment, a direction from the second face 421B toward the first face 421A is defined as a “first predetermined direction DD1”, a direction from the third face 421C toward the fourth face 421D is defined as a “third predetermined direction DD3”, and the upward direction orthogonal to the “first predetermined direction DD1” and the “third predetermined direction DD3” is defined as a “second predetermined direction DD2”.

The drive rail 42 extends along the first predetermined direction DD1. The drive rail 42 is positioned below the heating cooking chamber 100A. Specifically, the drive rail 42 is accommodated in the space R between the bottom wall 1D and the bottom outer wall 1F.

The support member 25 moves along the drive rail 42. In other words, the support member 25 moves along the first predetermined direction DD1. Specifically, the support member 25 is inserted into the first through hole 51. The support member 25 is slidably supported by the drive rail 42. Specifically, the support member 25 includes a protruding portion 25B on the upper surface thereof. On the other hand, the drive rail 42 includes a gripping portion 429 on the lower surface thereof. The gripping portion 429 grips the protruding portion 25B.

The drive rail 42 includes a rotation shaft hole 422, a first holding hole 423, and a second holding hole 424. Each of the first holding hole 423 and the second holding hole 424 is an example of a “through hole”. Each of the rotation shaft hole 422, the first holding hole 423, and the second holding hole 424 pass through the plate-like member 421 along the second predetermined direction DD2. The shape of the rotation shaft hole 422 is a substantially cylindrical shape.

Each of the first holding hole 423 and the second holding hole 424 extends in the third predetermined direction DD3. Specifically, each of the first holding hole 423 and the second holding hole 424 has a substantially elliptic cylindrical shape.

In the first predetermined direction DD1, the rotation shaft hole 422 is separated from the first holding hole 423 and the second holding hole 424. Specifically, the first holding hole 423 is disposed at a position separated from the rotation shaft hole 422 by a first distance in the direction opposite to the first predetermined direction DD1. Further, the second holding hole 424 is disposed at a position separated from the rotation shaft hole 422 by a second distance in the direction opposite to the first predetermined direction DD1. The second distance is greater than the first distance.

Next, a rotation shaft portion 43 will be described in detail. The pull-out type heating cooking apparatus 100 further includes the rotation shaft portion 43.

The rotation shaft portion 43 rotates the drive rail 42 using the second predetermined direction DD2 as a rotation axis. More specifically, the rotation shaft portion 43 holds the drive rail 42 so that the drive rail 42 rotates in a rotation direction RR with the second predetermined direction DD2 as the rotation axis. Specifically, the rotation shaft portion 43 includes, for example, a cylindrical body 43a and a plate-like body 43b. The plate-like body 43b is disposed at a lower end portion of the cylindrical body 43a.

An upper end portion of the cylindrical body 43a is attached to the bottom wall 1D of the heating cooking chamber 100A. More specifically, the cylindrical body 43a extends along the second direction D2 from the bottom wall 1D. Further, the cylindrical body 43a is disposed in the rotation shaft hole 422 of the drive rail 42. In addition, the plate-like body 43b is disposed below the drive rail 42. As a result, the drive rail 42 can be held.

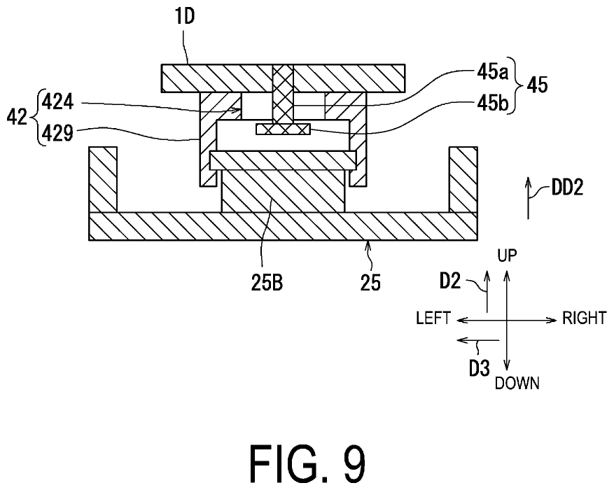

Next, a second holding portion 45 will be described in detail with reference to FIG. 6 to FIG. 9. FIG. 9 is a cross-sectional view illustrating the pull-out type heating cooking apparatus 100 taken along a section line IX in FIG. 7. As illustrated in FIG. 6 to FIG. 9, the pull-out type heating cooking apparatus 100 further includes a first holding portion 44 and the second holding portion 45. Each of the first holding portion 44 and the second holding portion 45 is an example of a “holding portion”. Note that the first holding portion 44 has the same configuration as the second holding portion 45.

Specifically, the second holding portion 45 includes a cylindrical body 45a and a plate-like body 45b. The plate-like body 45b is disposed at a lower end portion of the cylindrical body 45a. An upper end portion of the cylindrical body 45a is attached to the bottom wall 1D of the heating cooking chamber 100A. The rotation shaft portion 43 is separated from the first holding portion 44 and the second holding portion 45 in the first predetermined direction DD1.

More specifically, the cylindrical body 45a extends along the second direction D2 from the bottom wall 1D. The cylindrical body 45a is disposed at a center portion inside the second holding hole 424 of the drive rail 42. In addition, the plate-like body 45b is disposed below the drive rail 42. As a result, the drive rail 42 can be held.

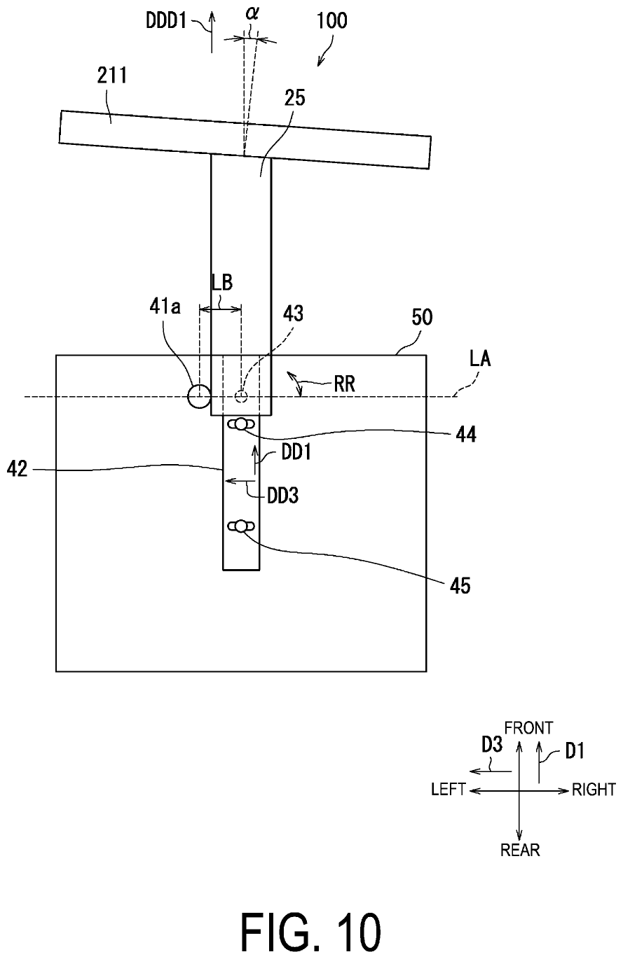

Here, there may be a case in which parallelism between the plate-like member 211 and the panel 50 is lost. With reference to FIG. 10, the case in which the parallelism between the plate-like member 211 and the panel 50 is lost will be described. FIG. 10 is a bottom view illustrating the pull-out type heating cooking apparatus 100 in the state in which the bottom outer wall 1F is removed. More specifically, FIG. 10 illustrates the pull-out type heating cooking apparatus 100 in the state in which the pull-out body 2 is pulled out.

As illustrated in FIG. 10, the drive rail 42 is disposed substantially parallel to the first direction D1. In other words, the first predetermined direction DD1 is set substantially parallel to the first direction D1. In addition, the support member 25 is disposed substantially parallel to the drive rail 42. In other words, the first set direction DDD1 is set substantially parallel to the first direction D1. On the other hand, the angle of the first set direction DDD1 with respect to the plate-like member 211 is an angle α. Thus, the plate-like member 211 is not orthogonal to the first direction D1.

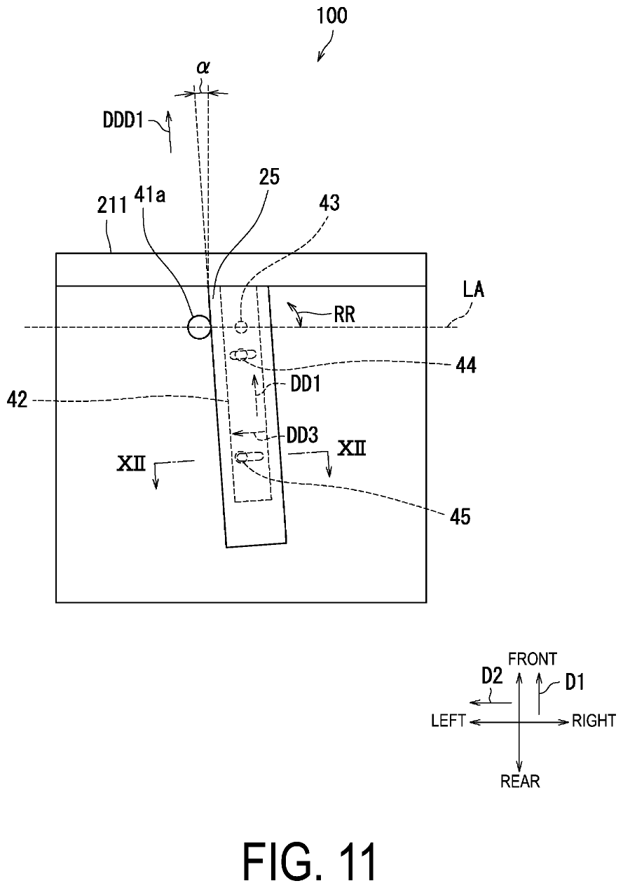

Next, with reference to FIG. 11, the pull-out type heating cooking apparatus 100 in a state in which the plate-like member 211 is positioned at the closed position will be described in detail. FIG. 11 is a bottom view illustrating the pull-out type heating cooking apparatus 100 in the state in which the bottom outer wall 1F is removed. More specifically, FIG. 11 illustrates the pull-out type heating cooking apparatus 100 in the state in which the pull-out body 2 is accommodated.

As illustrated in FIG. 11, the angle between the drive rail 42 and the first direction D1 is the angle α. In other words, the angle between the first predetermined direction DD1 and the first direction D1 is the angle α. In addition, the support member 25 is disposed substantially parallel to the drive rail 42. In other words, the angle between the first set direction DDD1 and the first direction D1 is the angle α. On the other hand, the angle of the first set direction DDD1 with respect to the plate-like member 211 is the angle α. Thus, the lid portion 21 is orthogonal to the first direction D1.

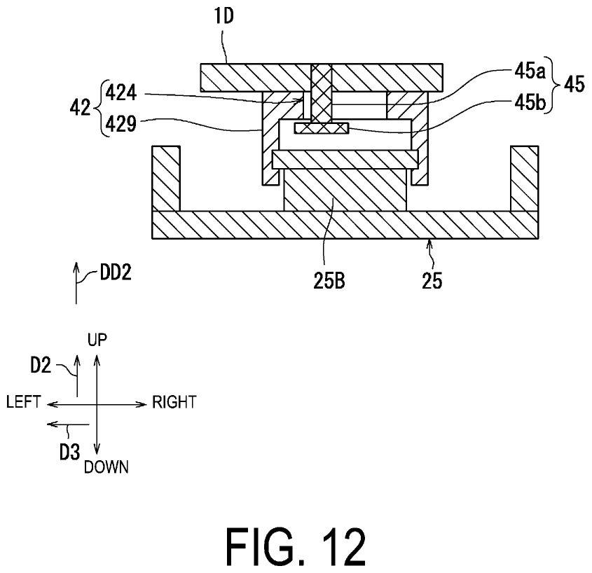

Next, the second holding portion 45 will be described in detail with reference to FIG. 12. FIG. 12 is a cross-sectional view illustrating the pull-out type heating cooking apparatus 100 taken along a section line XII in FIG. 11. As illustrated in FIG. 12, the second holding portion 45 holds the drive rail 42 to be freely rotatable with respect to the heating cooking chamber 100A. Specifically, the second holding portion 45 holds the drive rail 42 so that the drive rail 42 rotates within a predetermined rotation range with respect to the heating cooking chamber 100A.

More specifically, since the rotation shaft hole 422 and the second holding hole 424 are separated from each other, when the drive rail 42 rotates, the second holding hole 424 moves with respect to the bottom wall 1D of the heating cooking chamber 100A. As a result, the cylindrical body 45a is disposed at a left portion inside the second holding hole 424 of the drive rail 42. Specifically, the cylindrical body 45a moves from the center portion to the left portion inside the second holding hole 424.

As described above, since the rotation shaft portion 43 rotates the drive rail 42 using the second predetermined direction DD2 as the rotation axis, even if the parallelism between the plate-like member 211 and the panel 50 is lost, the parallelism between the plate-like member 211 and the panel 50 can be accurately maintained when the lid portion 21 is moved to the position at which the lid portion 21 covers the opening portion 100B.

In addition, since the rotation shaft portion 43 is separated from the first holding portion 44 and the second holding portion 45, the drive rail 42 can be stably held.

Furthermore, since the second holding portion 45 includes the cylindrical body 45a and the plate-like body 45b, the parallelism between the plate-like member 211 and the panel 50 can be accurately maintained with a simple configuration.

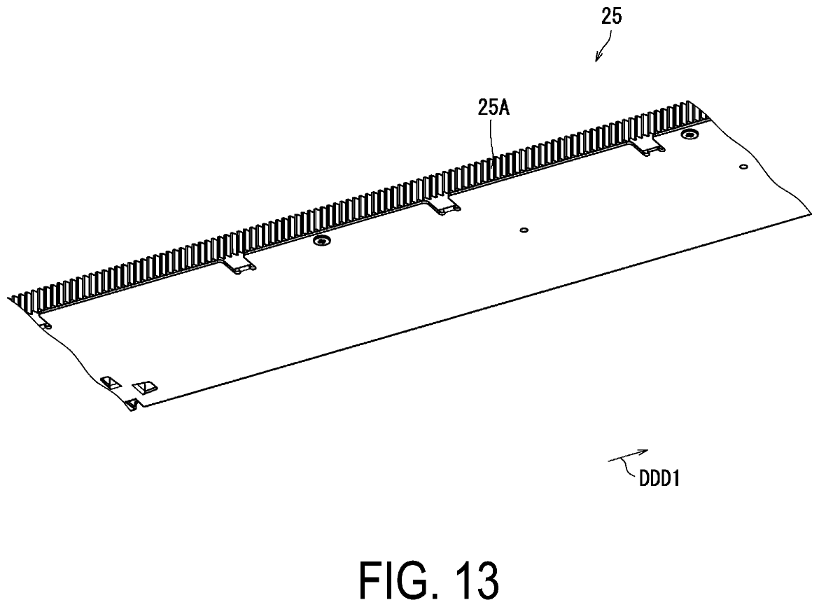

Next, a method of moving the plate-like member 211 from the open position to the closed position will be described in detail with reference to FIG. 6 to FIG. 13. FIG. 13 is a perspective view illustrating the support member 25. As illustrated in FIG. 6 to FIG. 13, the support member 25 includes a rack 25A. The rack 25A includes a plurality of teeth.

Meanwhile, the pull-out type heating cooking apparatus 100 further includes a drive motor 41. The drive motor 41 is an example of a “motor”. The drive motor 41 includes a pinion 41a. The drive motor 41 rotates the pinion 41a.

The drive motor 41 is positioned below the heating cooking chamber 100A. Specifically, the drive motor 41 is accommodated in the space R between the bottom wall 1D and the bottom outer wall 1F. The pinion 41a engages with the rack 25A of the support member 25. The support member 25 moves as a result of rotation of the pinion 41a.

The rotation shaft portion 43 and the drive motor 41 are attached so that the rack 25A and the pinion 41a are engaged with each other even when the drive rail 42 is rotated with respect to the heating cooking chamber 100A. As a result, the support member 25 can move automatically.

For example, the rotation shaft portion 43 and the drive motor 41 are attached to the heating cooking chamber 100A so that a virtual line LA connecting the rotation shaft portion 43 and the pinion 41a is substantially parallel to the panel 50.

More specifically, when the plate-like member 211 is positioned at the open position, the drive rail 42 is disposed substantially parallel to the first direction D1. The cylindrical body 45a is disposed at the center portion inside the second holding hole 424 of the drive rail 42. The distance between the rotation shaft portion 43 and the drive motor 41 is a predetermined distance LB.

As the support member 25 moves along the drive rail 42, the distance between the plate-like member 211 and the panel 50 decreases. As the distance between the plate-like member 211 and the panel 50 decreases, a portion of the plate-like member 211 and a portion of the panel 50 come into contact with each other.

When the portion of the plate-like member 211 and the portion of the panel 50 come into contact with each other, the rotation shaft portion 43 rotates the drive rail 42 in the rotation direction RR using the second predetermined direction DD2 as the rotation axis. The angle between the drive rail 42 and the first direction D1 is the angle α. The cylindrical body 45a is disposed at the left portion inside the second holding hole 424 of the drive rail 42, and the distance between the rotation shaft portion 43 and the drive motor 41 is the predetermined distance LB. As a result, even when the drive rail 42 is rotated with respect to the heating cooking chamber 100A, the rack 25A and the pinion 41a can be engaged with each other.

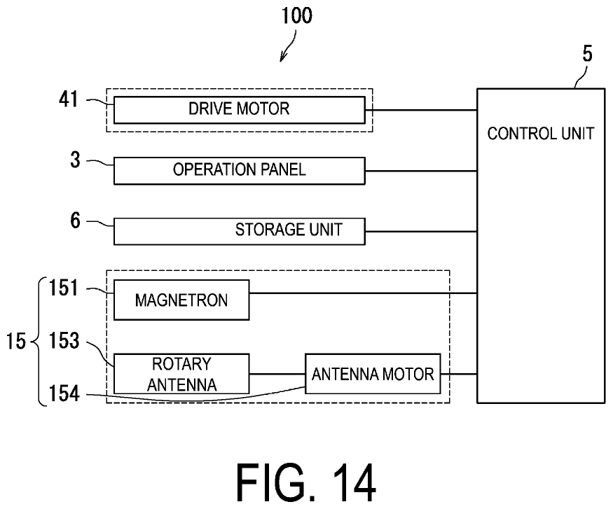

A configuration of the pull-out type heating cooking apparatus 100 will be described in detail with reference to FIG. 14. FIG. 14 is a block diagram illustrating a configuration of the pull-out type heating cooking apparatus 100 according to the present embodiment.

As illustrated in FIG. 14, the pull-out type heating cooking apparatus 100 further includes a microwave supply unit 15. The microwave supply unit 15 supplies microwaves into the heating cooking chamber 100A. Specifically, the microwave supply unit 15 includes a radiation chamber, a magnetron 151, a waveguide, a rotary antenna 153, and an antenna motor 154. The magnetron 151 generates microwaves. The waveguide propagates the microwaves generated by the magnetron 151 to the radiation chamber. The rotary antenna 153 is accommodated in the radiation chamber. The antenna motor 154 drives the rotary antenna 153. The rotary antenna 153 agitates microwaves and supplies the microwaves into the heating cooking chamber 100A.

The control unit 5 controls the magnetron 151, the antenna motor 154, the drive motor 41, the operation panel 3, and the storage unit 6 by executing control programs stored in the storage unit 6.

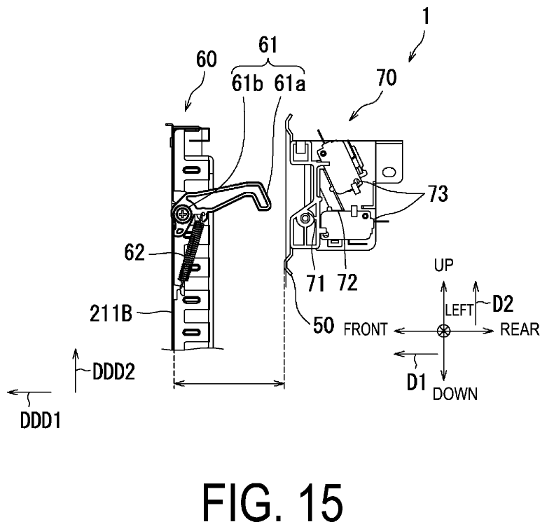

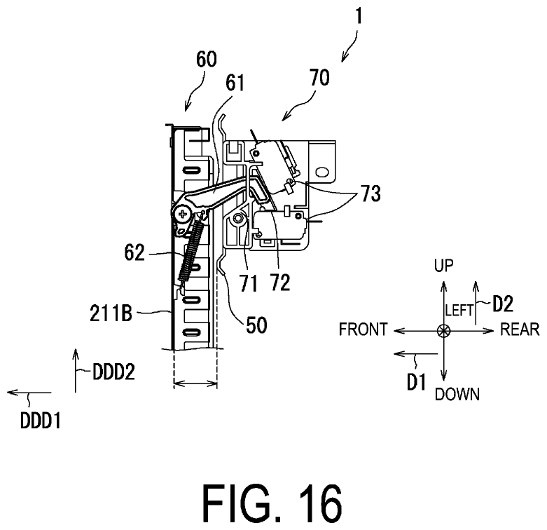

Next, the pull-out body 2 will be described in detail once again with reference to FIG. 4, FIG. 5, FIG. 15, and FIG. 16. FIG. 15 and FIG. 16 are cross-sectional views illustrating a first connecting member 60 and a first member to be connected 70 according to the present embodiment. As illustrated in FIG. 4 and FIG. 5, the pull-out type heating cooking apparatus 100 further includes the first connecting member 60 and a second connecting member 160.

Each of the first connecting member 60 and the second connecting member 160 connects the heating chamber 1 and the lid portion 21 when the lid portion 21 is positioned at the closed position.

The first connecting member 60 and the second connecting member 160 are attached to the lid portion 21. The first connecting member 60 and the second connecting member 160 face each other substantially in the third set direction DDD3. The first connecting member 60 is attached at an edge portion on the right side of the second face 211B of the lid portion 21 and above the placing portion 22. In addition, the second connecting member 160 is attached at an edge portion on the left side of the second face 211B of the lid portion 21 and above the placing portion 22.

Specifically, each of the first connecting member 60 and the second connecting member 160 includes a hook member 61 and an elastic member 62.

The hook member 61 is a plate-like member having the front-rear direction (substantially the first set direction DDD1) as the longitudinal direction. The hook member 61 includes a claw portion 61a and a rotation pin portion 61b. The rotation pin portion 61b is positioned at one end portion of the hook member 61. The rotation pin portion 61b pivots about a rotation axis extending substantially along the third set direction DDD3. On the other hand, the claw portion 61a has a protruding portion that protrudes downward. The claw portion 61a is positioned at the other end portion of the hook member 61. As a result, the claw portion 61a is pivotable about the rotation pin portion 61b.

The elastic member 62 acts on the hook member 61 such that the claw portion 61a is positioned at a predetermined position with respect to the second face 211B. The elastic member 62 is, for example, a coil spring. One end portion of the coil spring is attached to the hook member 61, and the other end portion of the coil spring is attached to the second face 211B.

Next, the first member to be connected 70 to which the first connecting member 60 is connected will be described in detail. The heating chamber 1 further includes the first member to be connected 70 and a second member to be connected 170.

The first member to be connected 70 and the second member to be connected 170 are attached to the heating chamber 1. The first member to be connected 70 is attached at an edge portion on the right side of the panel 50 and above the placing portion 22. More specifically, the first member to be connected 70 is attached to the fifth through hole 55. In addition, the second member to be connected 170 is attached at an edge portion on the left side of the panel 50 and above the placing portion 22. More specifically, the second member to be connected 170 is attached to the fourth through hole 54.

Specifically, the first member to be connected 70 includes an inclined face portion 71, a hole 72, and two sensors 73. Each of the two sensors 73 is an example of a “detection unit”. The inclined face portion 71 has an inclined surface that gradually increases from a predetermined height. The hole 72 is positioned at the predetermined height and positioned on the rear side of the inclined face portion 71. The shape of the hole 72 corresponds to the shape of the claw portion 61a. The two sensors 73 output a signal to the control unit 5 when the claw portion 61a is positioned in the hole 72. On the other hand, when the claw portion 61a is not positioned in the hole 72, the two sensors 73 do not output the signal to the control unit 5.

Further, the second member to be connected 170 includes the inclined face portion 71 and the hole 72. The inclined face portion 71 has an inclined surface that gradually increases from a predetermined height. The hole 72 is positioned at the predetermined height and positioned on the rear side of the inclined face portion 71. The shape of the hole 72 corresponds to the shape of the claw portion 61a.

The control unit 5 controls driving of the microwave supply unit 15. More specifically, the control unit 5 drives the magnetron 151 and the antenna motor 154 after receiving the signal from the two sensors 73.

Next, a connecting method for connecting the heating chamber 1 and the lid portion 21 will be described in detail. First, the lid portion 21 is moved from the open position to the closed position. In other words, the distance between the panel 50 and the second face 211B decreases.

Next, when the distance between the panel 50 and the second face 211B decreases, the claw portion 61a comes into contact with the inclined face portion 71 of the first member to be connected 70.

Next, when the distance between the panel 50 and the second face 211B further decreases, the claw portion 61a comes into contact with the inclined face portion 71 of the first member to be connected 70, so that the claw portion 61a is pushed up from the predetermined position against the action of the elastic member 62.

Next, when the distance between the panel 50 and the second face 211B further decreases, the claw portion 61a is pulled down to the predetermined position by the action of the elastic member 62.

As a result, the claw portion 61a is positioned in the hole 72. The distance between the panel 50 and the second face 211B is a predetermined distance. The two sensors 73 output the signal to the control unit 5 when the claw portion 61a is positioned in the hole 72.

As described above, the distance between the second face 211B on the rear side of the lid portion 21 and the panel 50 on the front side of the heating chamber 1 can be held so that the distance between the second face 211B on the rear side of the lid portion 21 and the panel 50 on the front side of the heating chamber 1 is the predetermined distance.

Further, there may be a case in which the parallelism between the second face 211B on the rear side of the lid portion 21 and the panel 50 on the front side of the heating chamber 1 is lost. For example, the distance between the second face 211B at which the first connecting member 60 is positioned and the panel 50 may be shorter than the distance between the second face 211B at which the second connecting member 160 is positioned and the panel 50.

Specifically, when the lid portion 21 is moved to the closed position, the first connecting member 60 connects the heating chamber 1 and the lid portion 21. On the other hand, the second connecting member 160 does not connect the heating chamber 1 and the lid portion 21. The control unit 5 drives the drive motor 41 for a predetermined period of time after the two sensors 73 have made a detection. The predetermined period of time is, for example, 100 milliseconds. As a result, the drive rail 42 rotates with the rotation shaft portion 43 as the rotation axis. The second connecting member 160 connects the heating chamber 1 and the lid portion 21.

As described above, when the parallelism between the second face 211B on the rear side of the lid portion 21 and the panel 50 on the front side of the heating chamber 1 is lost, the control unit 5 drives the drive motor 41 for the predetermined period of time after the two sensors 73 have made the detection, so it is possible to accurately maintain the parallelism between the second face 211B on the rear side of the lid portion 21 and the panel 50 on the front side of the heating chamber 1. As a result, it is possible to suppress the leakage of microwaves from the inside of the heating cooking chamber 100A. In addition, when the distance between the second face 211B at which the first connecting member 60 is positioned and the panel 50 is longer than the distance between the second face 211B at which the second connecting member 160 is positioned and the panel 50, the drive rail 42 rotates before the two sensors 73 make the detection. Thus, the parallelism between the second face 211B on the rear side of the lid portion 21 and the panel 50 on the front side of the heating chamber 1 can be accurately maintained.

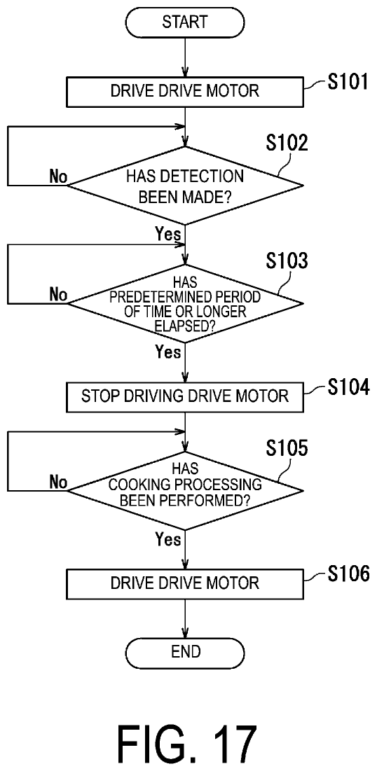

Next, a cooking method by the pull-out type heating cooking apparatus 100 according to the present embodiment will be described with reference to FIG. 17. FIG. 17 is a flowchart for explaining the cooking method by the pull-out type heating cooking apparatus 100.

As illustrated in FIG. 17, at step S101, the control unit 5 drives the drive motor 41 when the lid portion 21 moves to the closed position.

Next, at step S102, the control unit 5 determines whether the signal has been received from the two sensors 73. When the control unit 5 determines at step S102 that the signal has not been received from the two sensors 73, the processing returns to step S102.

On the other hand, when the control unit 5 determines at step S102 that the signal has been received from the two sensors 73, the processing proceeds to step S103. At step S103, the control unit 5 determines whether the predetermined period of time or longer has elapsed.

When the control unit 5 determines at step S103 that the predetermined period of time or longer has not elapsed, the processing returns to step S103. On the other hand, when the control unit 5 determines at step S103 that the predetermined period of time or longer has elapsed, the processing proceeds to step S104.

Next, at step S104, the control unit 5 stops driving of the drive motor 41.

Next, at step S105, the control unit 5 determines whether to perform cooking processing. When the control unit 5 determines at step S105 not to perform the cooking processing, the processing returns to step S105. On the other hand, when the control unit 5 determines at step S105 to perform the cooking processing, the processing proceeds to step S106.

Next, at step S106, the control unit 5 drives the drive motor 41. Then, the cooking method ends.

As described above, since the control unit 5 drives the drive motor 41 during cooking, the parallelism between the second face 211B on the rear side of the lid portion 21 and the panel 50 on the front side of the heating chamber 1 can be accurately maintained. As a result, it is possible to suppress the leakage of microwaves from the inside of the heating cooking chamber 100A. In addition, even when a configuration is employed in which reverse rotation is performed to offset backlash, in order to reduce an engagement load between the rack 25A and the pinion 41a, it is possible to suppress the leakage of microwaves from the inside of the heating cooking chamber 100A.

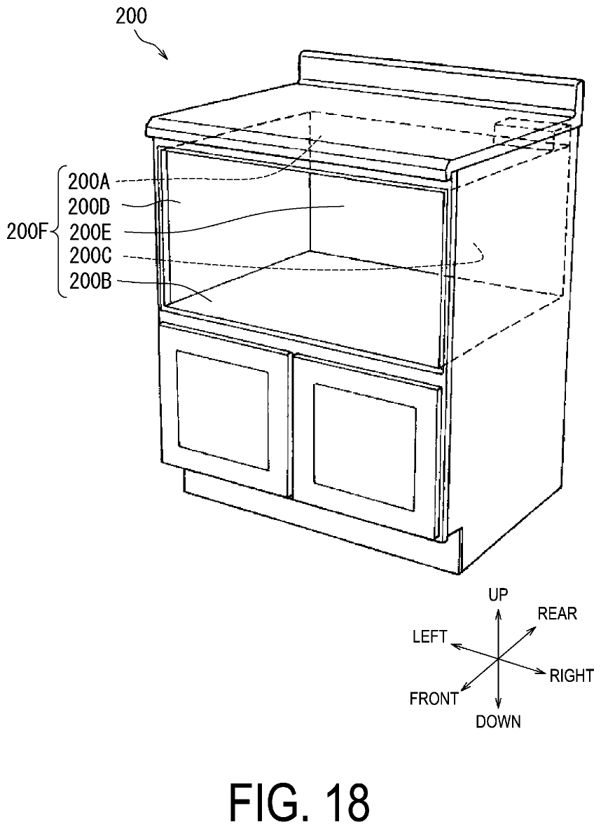

Next, a cabinet 200 to which the pull-out type heating cooking apparatus 100 is attached will be described with reference to FIG. 18. FIG. 18 is a diagram illustrating an external appearance of the cabinet 200 to which the pull-out type heating cooking apparatus 100 according to the present embodiment is attached.

The pull-out type heating cooking apparatus 100 is installed in the cabinet 200 in a built-in manner. As illustrated in FIG. 10, the cabinet 200 includes an upper wall 200A, a lower wall 200B, a right wall 200C, a left wall 200D, and a rear wall 200E. The upper wall 200A, the lower wall 200B, the right wall 200C, the left wall 200D, and the rear wall 200E form an accommodation portion 200F. The accommodation portion 200F is a rectangular parallelepiped space into which the pull-out type heating cooking apparatus 100 is fitted.

The embodiment of the present invention has been described above with reference to the accompanying drawings. However, the present invention is not limited to the embodiment described above, and the present invention can be implemented in various modes without departing from the gist thereof. The drawings primarily schematically illustrate each of the constituent elements for the sake of easier understanding, and the thickness, length, quantity, and the like of each of the illustrated constituent elements are different from the actual thickness, length, quantity, and the like by reason of creation of the drawings. Further, the material, shape, dimensions, and the like of each of the constituent elements illustrated in the embodiment described above are merely examples and are not particularly limited, and various modifications can be made within the scope not substantially departing from the effects of the present invention.

(1) As described above with reference to FIG. 1 to FIG. 18, the pull-out type heating cooking apparatus 100 includes the microwave supply unit 15, but the present invention is not limited thereto. For example, the pull-out type heating cooking apparatus 100 may further include an air supply unit that supplies hot air to the inside of the heating cooking chamber 100A. As a result, it is possible to suppress the leakage of hot air from the inside of the heating cooking chamber 100A.

(2) The pull-out type heating cooking apparatus 100 may further include a grill heater. As a result, it is possible to suppress the leakage of hot air from the inside of the heating cooking chamber 100A.

(3) As described above with reference to FIG. 1 to FIG. 18, the pull-out type heating cooking apparatus 100 includes the drive motor 41, but the present invention is not limited thereto. For example, the pull-out type heating cooking apparatus 100 may not include the drive motor 41, and the support member 25 may be moved manually.

### INDUSTRIAL APPLICABILITY

The present invention provides a heating cooking apparatus, and the provided heating cooking apparatus has industrial applicability.

### REFERENCE SIGNS LIST

21 Lid portion
25 Support member (slide plate)
41 Drive motor
43 Rotation shaft portion
44, 45 Holding portion
50 Panel (plate portion)
100 Pull-out type heating cooking apparatus
100B Opening
421 Drive rail (slide rail)
DD1 First predetermined direction
DD2 Second predetermined direction

1. A heating cooking apparatus comprising:
a heating cooking chamber including a plate portion disposed at an outer periphery of an opening;
a slide rail extending along a first predetermined direction;
a slide plate configured to move along the slide rail;
a lid portion attached to the slide plate and configured to open and close the opening;
a rotation shaft portion configured to rotate the slide rail using a second predetermined direction as a rotation axis, the second predetermined direction being orthogonal to the first predetermined direction; and
a holding portion configured to hold the slide rail to be freely rotatable with respect to the heating cooking chamber.

2. The heating cooking apparatus according to claim 1,
wherein the rotation shaft portion and the holding portion are attached to a bottom wall of the heating cooking chamber, and
the holding portion and the rotation shaft portion are separated from each other in the first predetermined direction.

3. The heating cooking apparatus according to claim 2,
wherein the holding portion
extends along the second predetermined direction, and
includes a cylindrical body and a plate-like body, an upper end portion of the cylindrical body being attached to the bottom wall of the heating cooking chamber, and the plate-like body being disposed at a lower end portion of the cylindrical body,
the slide rail includes a through hole passing through the slide rail along the second predetermined direction,
the through hole is orthogonal to the first predetermined direction and extends in a third predetermined direction orthogonal to the second predetermined direction, and
the cylindrical body is disposed in the through hole.

4. The heating cooking apparatus according to claim 1, further comprising:
a motor including a pinion and configured to rotate the pinion; and
a control unit configured to drive the motor,
wherein the slide plate includes a rack, and
the motor and the rotation shaft portion are attached at a position at which the rack and the pinion engage with each other, even when the slide rail rotates with respect to the heating cooking chamber.

5. The heating cooking apparatus according to claim 4,
wherein the motor and the rotation shaft portion are attached to the heating cooking chamber to cause a virtual line connecting the rotation shaft portion and the pinion to be substantially parallel with the plate portion.

6. The heating cooking apparatus according to claim 4,
wherein the lid portion includes
a first connecting member, and
a second connecting member facing the first connecting member,
the first connecting member and the second connecting member are connected with the heating cooking chamber when the lid portion is moved to a position at which the lid portion covers the opening,
the heating cooking chamber further includes a detection unit configured to detect the connection between the heating cooking chamber and the first connecting member, and
the control unit drives the motor for a predetermined period of time after the detection unit detects the connection.

7. The heating cooking apparatus according to claim 4,
wherein the control unit drives the motor during cooking.

8. The heating cooking apparatus according to claim 1, further comprising
a microwave supply unit configured to supply microwaves into the heating cooking chamber.
